(19) United States
(12) Patent Application Publication
(10) Pub. No.: US 2016/0059047 A1
(43) Pub. Date: Mar. 3, 2016

(54) METHOD, APPARATUS, AND SYSTEM FOR PROVIDING CONTROLLED ATMOSPHERE IN CONFINED SPACES

(71) Applicant: CHEMBIO SHELTER, INC., ALLENTOWN, PA (US)

(72) Inventor: Edward V. Roscioli, Easton, PA (US)

(21) Appl. No.: 14/839,089

(22) Filed: Aug. 28, 2015

Related U.S. Application Data
(60) Provisional application No. 62/043,075, filed on Aug. 28, 2014.

(51) Int. Cl. A62B 9/00; A62B 7/12; A62B 7/02

(52) U.S. Cl. CPC A62B 9/003; A62B 7/02; A62B 7/12

(57) ABSTRACT

A method, system and apparatus for mobile deployment of a supply of safe breathable air in sufficient quantity and quality to support life functions without further augmentation in respirable particles of about 10 μm or less in aerodynamic equivalent diameter are captured and removed from the external ambient atmosphere as are water soluble co-pollutants prior to introduction of safe breathable air to the confined space, and where manipulation of the sensible and latent heat content of the supplied safe breathable air is undertaken to maintain a differential in vapor pressure such that it promotes a skin evaporation rate that ensures that the body core temperature can be maintained by its thermoregulatory processes.

### BACKGROUND

1. Field of the Invention

This invention relates broadly to providing an atmosphere such that it supports life in spaces that, absent such action, constitute respiratory and/or thermal hazards. More particularly, this invention relates to methods, apparatus and systems for the habituation and supply of a life sustaining atmosphere in a controlled manner to persons occupying a confined space.

2. Description of the Related Art

A confined space is one that is large enough and so configured that a person can bodily enter, has limited or restricted means for entry or exit, is not designed for continuous occupancy, and which could trap or asphyxiate an entrant. Examples of confined spaces include: storage tanks, process vessels, bins, silos, boilers, ventilation or exhaust ducts, sewers, pipe chassis, underground utility vaults, tunnels, trenches, pits, pipelines and emergency refuges from hazardous environments, including mine refuge alternatives, collective protection shelters, and safe rooms.

Current art includes either providing mechanical ventilation with external air to the space using fans, or a safe atmosphere in the form of personal protective equipment isolating the person from hazardous atmospheric conditions such as a self-contained breathing apparatus or supplied air system using sealed suits, masks or other enclosures supplied by compressors or compressed air tanks

### SUMMARY OF THE INVENTION

The currently available methods for providing a controlled atmosphere to occupants of a confined space, are limited, for example, in that they are impractical when the supplied air may introduce constituents that are themselves injurious to the occupants. Examples include but are not limited to the introduction of hazardous exhaust fumes or volatized lubricants, respirable particles, or air temperatures exceeding safe limits.

It is an object of the present invention to provide a supply of safe breathable air in sufficient quantity and quality to support life functions without further augmentation.

An embodiment of the invention provides for mobile deployment by mounting the safe air supply apparatus on a trailer, loading it on a truck or airlifting the unit by helicopter or transport plane.

According to a preferred embodiment respirable particles of about 10 μm or less in aerodynamic equivalent diameter are captured and removed from the external ambient atmosphere as are water soluble co-pollutants prior to introduction of safe breathable air to the confined space.

An additional optional object of the invention is manipulation of the sensible and latent heat content of the supplied safe breathable air to maintain a differential in vapor pressure such that it promotes a skin evaporation rate that ensures that the body core temperature can be maintained by its thermoregulatory processes.

The invention includes the means to maintain a higher pressure inside said confined space when compared to the adjacent atmosphere. This pressure difference is sufficient to prevent infiltration of hazardous gases.

The invention allows for local or optionally remote control and/or monitoring of the system's operating parameters with options for automatic or manual control.

Accordingly, there is provided according to an embodiment of the invention a method, apparatus, or system for providing controlled atmosphere in confined spaces including an environmental conditioning unit capable of dehumidifying the air passing through it, in fluid communication with a blower, compressor, or other device that would cause air to move through the environmental conditioning unit. The environmental conditioning unit and blower, compressor, or other device that would cause air to move through the environmental conditioning unit further in fluid communication with a flexible hose, tube, pipe, duct, or other conduit that can be connected to a confined space.

According to another embodiment of the invention, the environmental conditioning unit is capable of heating the air passing through it. According to a preferred embodiment of the invention, the environmental conditioning unit may be manufactured by:
Desert Aire N120 W18485 Freistadt Rd Germantown, Wis. 53022 United States Telephone: (262) 946-7400 www.desert.aire.com

According to a further embodiment of the invention, the environmental conditioning unit may be an Aura™ Series Dehumidifier, Unit Model #: QS10M4E99999.

According to another embodiment of the invention, the blower, compressor, or other device that would cause air to move through the environmental conditioning unit is a blower, for example Model 7011 manufactured by:
Tuthill Vacuum & Blower Systems 4840 West Kearney Street Springfield, Mo. USA 65803-8702 Phone: 417.865.8715 www.tuthillvacuumblower.com

According to another embodiment of the invention, the flexible hose, tube, pipe, duct, or other conduit may be a flexible pipe.

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations supplying breathable air within a confined space, it should be understood that the concepts presented herein may be used in other various configurations consistent with this disclosure.

### BRIEF DESCRIPTION OF THE DRAWINGS

FIG. 1: Illustration of current art of personal protective equipment for confined spaces.

FIG. 2: Illustration of current art for confined space ventilation.

FIG. 3: Drawing of Side View of Environmental Conditioning Unit and Blower.

FIG. 3B: Isometric illustration of Environmental Conditioning Unit and Blower.

FIG. 4: Process Flow Diagram illustrating the process.

FIG. 5: Graph showing the relationship between apparent temperature, air temperature, and relative humidity.

FIG. 5B: Table insert for FIG. 5 discussing effects of various apparent temperature ranges.

FIG. 6: Illustration of the sensor and control system.

FIG. 7: Illustration of transport embodiments.

FIG. 8: Illustration of a particular embodiment, providing safe breathable air to a subterranean confined space occupied during maintenance or as a refuge in the event of an emergency.

FIG. 9: Illustration of a particular embodiment providing safe breathable air to a storage tank occupied during maintenance.

### DETAILED DESCRIPTION OF THE INVENTION

In the following detailed description, reference is made to the accompanying drawings which form a part hereof, and in which are shown by way of illustration preferred embodiments of the invention. These embodiments are described in sufficient detail to enable those skilled in the art to make and use them, and it is to be understood that structural, logical or procedural changes may be made.

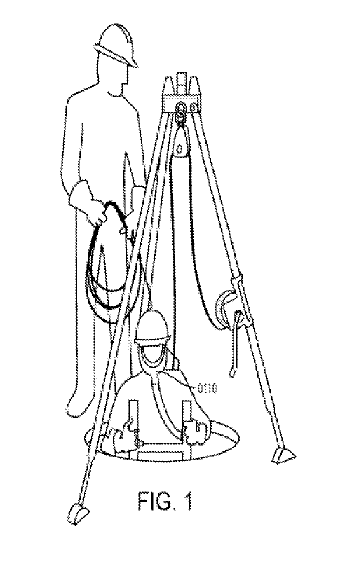

Referring now to FIG. 1, there is an illustration of current art for providing breathable air to those entering a confined space. Note that number 0110 identifies a typical supplied air mask donned by the individual upon entering the space.

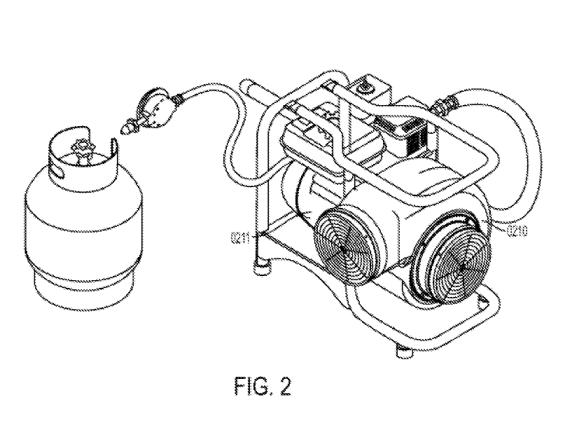

Referring now to FIG. 2, there is an illustration of the current art for providing ventilation for confined spaces in which persons are working without a supplied air mask. Number 0210 indicates a blower which moves untreated surface atmosphere to the confined space. Number 0211 indicates the power source for the blower, typically one of several forms of fossil fuel engine.

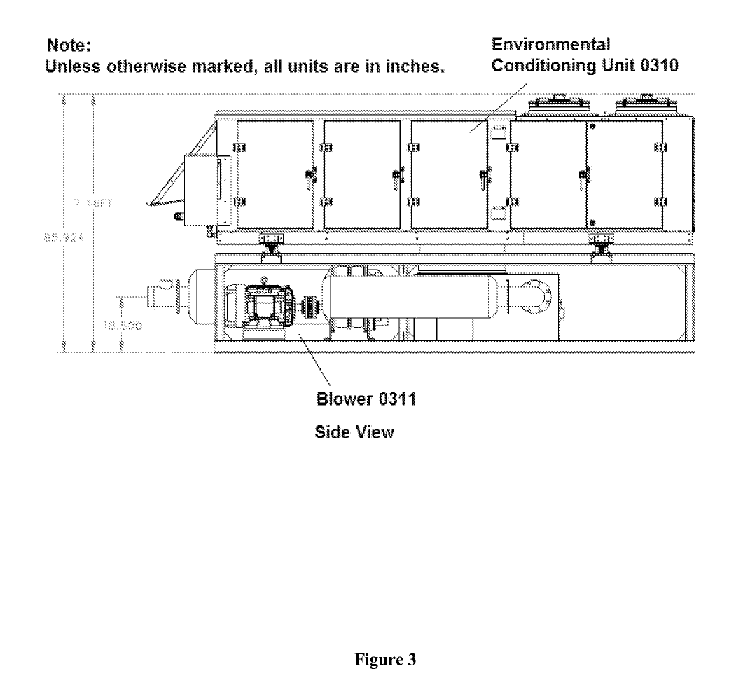

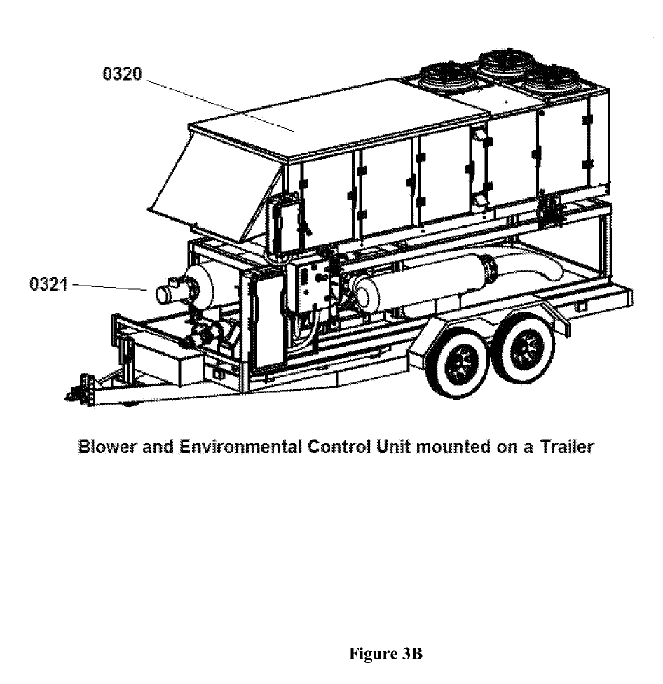

Referring now to FIG. 3, there is shown a drawing of an environmental conditioning unit according to an embodiment of the invention, described hereafter, number 0310, and a blower, number 0311.

Referring now to FIG. 3B, there is shown an isometric projection of an environmental conditioning unit according to an embodiment of the invention, described hereafter, number 0320, and a blower, number 311 mounted in the embodiment of a trailer indicated as 0321.

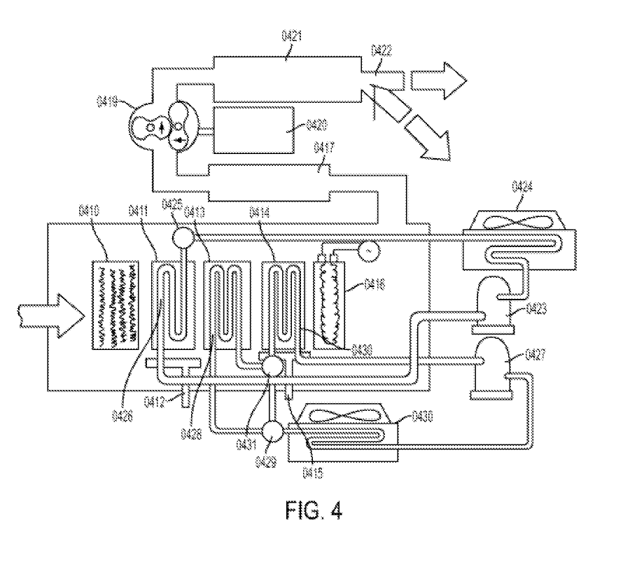

Referring now to FIG. 4, there is presented a line drawing of the environmental conditioning unit according to an embodiment of the invention. Atmospheric air is drawn through filters, 0410, where respirable particles are removed. The filters generally known as high efficiency particulate filters are sized such that 99.9 percent of particles greater than 0.1 microns are captured. Additional embodiments of the invention may include other filters such as activated carbon or catalyst for removal of hazardous gases, such as carbon monoxide.

Next the air flows through an evaporator subsystem shown as number 0411, where the apparent temperature, the general term for the perceived temperature caused by the combined effects of air temperature and relative humidity, is modified by lowering the thermal energy content of the air and the water vapor it contains. The majority of the heat is removed by condensing the water vapor in the air, since the specific heat of water is significantly larger than that of air. The ability of the air mass to transfer thermal energy is a function of the energy contained in the molecules that the air contains. Preferentially removing the higher specific heat water molecules reduces the effective thermal energy content of the resulting air mass to a greater extent than simply cooling the air. For example, the temperature of a small cup of water might be the same as the temperature of a large tub of water, but the tub of water has more heat because it has more water and thus more total thermal energy. By changing state from a gas to a liquid, the water releases significantly more energy than would occur in the simple cooling of equivalent air. By lowering the thermal energy of the resultant air mass, its ability to absorb heat generated by persons in confined spaces is increased. The consequence is a reduction in the risk of heat related injury to those in the confined space.

The water condensed from the air is collected in the drip pan, number 0412, and removed.

The air then passes through a super-heater subsystem, number 0413, where thermal energy is added to the air mass, increasing the temperature differential of the water vapor relative to the second evaporator cooling coils, number 0414. The air then passes into the second evaporator, where the water vapor is again condensed in drip pan number 0415, and thermal energy is removed. The number of reheat-condensation stages can be increased to that required by the ambient conditions. The mass of water within the air mass is lowered significantly below the dew point of the air in the confined space. Dew point is the temperature at which an air mass is fully saturated with water vapor. The lower dew points will enhance the ability of the human body's natural cooling mechanism to cool the body, further lowering the risk of heat related injury.

Since not all confined space entries occur when outside temperatures are high, the air then passes over an electric resistance heating subsystem, number 0416, to provide increased heat in the event that the ambient temperature is such that hypothermia is a concern.

The air then passes an inlet muffler silencer, number 0417, which attenuates the sound energy produced by the twin lobe positive displacement blower, number 0419. The twin lobe blower provides a high volume delivery of oil free air at a relatively constant volume through two figure eight shaped impellers rotating in counter directions. As each lobe passes the inlet connection, air is drawn into the blower cavity. The air is transferred around the perimeter of the cavity and is discharged through the discharge port on the opposite side of the blower housing. The twin lobe blower in the depicted embodiment operates at constant speed provided by the electric motor, 0420.

The air then passes an outlet muffler silencer, number 0421, which attenuates the sound energy produced by the twin lobe positive displacement blower, number 0419.

The air flow rate into the confined space is adjusted by diverting excess air though a gated branch fitting on the outlet pipe, number 0422.

Mechanical dehumidification is accomplished by continuously circulating, evaporating, and condensing a fixed supply of refrigerant in a closed system. Evaporation occurs at a low temperature and low pressure while condensation occurs at a high temperature and high pressure. Referring again to FIG. 4, the pressure of a refrigerant is elevated in compressor, number 0423, thus passing through a heat exchanger, number 0424, where ambient air is passed through it, lowering the pressure by removing heat. The refrigerant, still at a high pressure, then passes through an expansion valve, number 0425, where a significant reduction in pressure is introduced by a restriction in the line through which it flows, which, along with the reduced pressure resulting from exposure to the suction side of the compressor, dramatically reduces the pressure, thus lowering the temperature of the refrigerant as it flows through the evaporation coil, number 0426.

In the illustrated embodiment, one additional dehumidification circuit is provided which allows for the high pressure refrigerant from compressor, number 0427, to be partially redirected through coils in a super-heater coil, number 0428, by manipulating valve, 0429, to direct all or part of the flow to the superheater, in addition to, or in lieu of, the circuit's heat exchanger, number 0430. This allows the reheating of the air prior to crossing the lower temperature coils in the circuit, number 0430, where heat is again removed by refrigerant gas of lowered temperature from passing through expansion valve 0431.

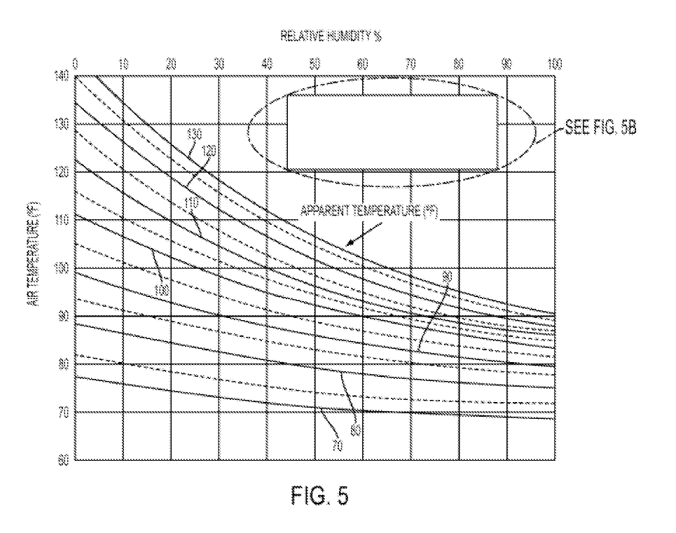

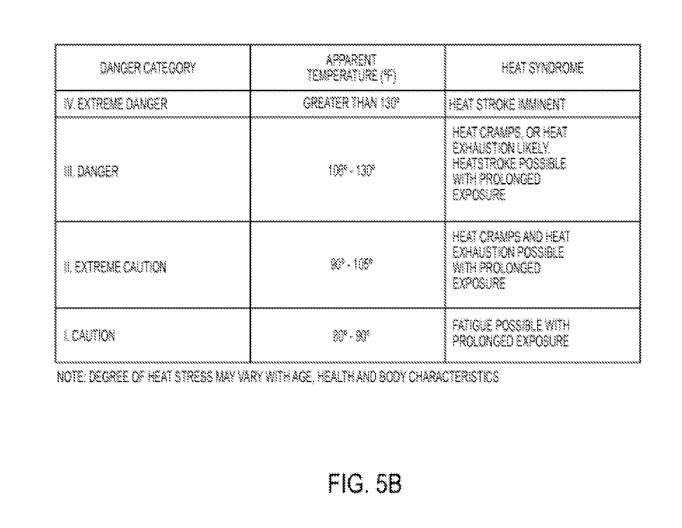

Referring now to FIG. 5; normally, the human body cools itself by opening pores on the skin and releasing water and salts. As the water evaporates, it transfers the body's heat to the air. Because water has a high latent heat, which is the heat required to change liquid water to vapor, this process usually carries away enough heat to cool the body. But the rate at which water, in this case, sweat, evaporates depends on how much water is already in the air.

High humidity combined with hot temperatures reduce the body's ability to cool itself increasing the risk of heat exhaustion, heat stroke, and other heat related health problems. The Heat Index, also referred to as Apparent Temperature, is an estimate of the temperature (in ° F.) that would similarly affect the body at normal humidity (about 20 percent). For example, if the actual temperature is 100° F. with 40 percent relative humidity, the heat index is 110 ° F., meaning the apparent temperature feels like 110 ° F. to the body. At 100% relative-humidity and 100° F., the apparent temperature is 195° F. At 100% relative humidity, at any temperature, sweat will not evaporate into the air and the body's thermal control mechanisms fail.

This invention teaches that, in confined spaces the critical factor in avoiding heat related injury is reducing the actual humidity in the space by focusing on the amount of water vapor in the supplied air. Actual humidity, a measure of water vapor quantity, is most practically measured as dew point. The dew point is the temperature at which the water vapor in the air condenses into liquid water at the same rate at which it evaporates. The higher the dew point, the higher the moisture content of the air. Dew point temperature is never greater than the air temperature at saturation (100% relative humidity).

This invention provides clean air supply at dew points below that of the air in the confined space. The low water content supply air mixes with the high water content confined space air lowering the moisture level in the mixture. As the cumulative number of air exchanges increase, the moisture in the confined space air will approach the lower value of the supplied air.

The rate at which sweat on the surface of the skin evaporates is determined by the difference in the vapor pressure of the sweat and that of the air in contact with the skin. To ensure adequate evaporation, the vapor pressure of the water in the confined space air must be less than that of fully wet skin. Fully wet skin only occurs if the air in contact with the skin cannot absorb the water as rapidly as it is being generated. These conditions occur as the apparent temperature or the heat index at the skin exceeds 90 degrees Fahrenheit and are precursors to heat related injuries.

FIG. 5B is a table insert for FIG. 5 showing the health effects of various apparent temperature ranges.

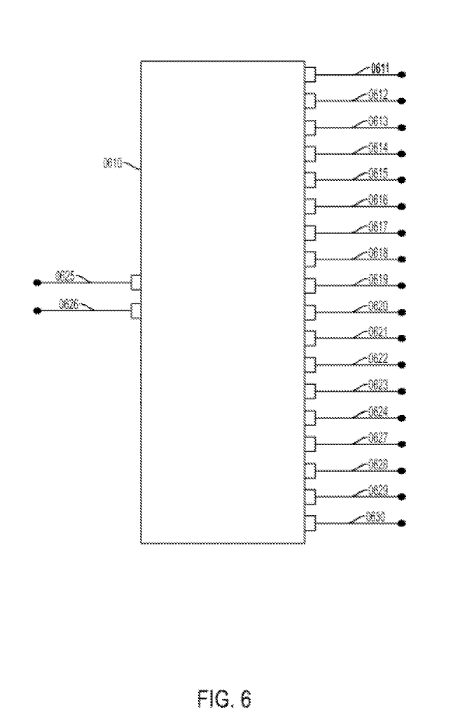

FIG. 6 illustrates the various measurement and control points that may be incorporated in various embodiments of the invention. The following sensor inputs and outputs are processed through a controller, 0610, which is connected to a graphical human user interface allowing the operator to monitor current conditions, and intervene if necessary.

Air temperature is measured by a temperature sensor, 0611, and humidity is measured by a humidity sensor, 0612. The differential pressure between inside the flexible pipe and outside the flexible pipe, at the exit of the environmental conditioning unit, is measured by a differential pressure sensor, 0613. These values are used to baseline the requirements for the mechanical dehumidification subsystem and will dictate the use or level of super-heat required to achieve the desired dehumidification.

The filter bank measurement involves monitoring the pressure drop across the filters with a differential pressure sensor, 0614, monitoring for an increase that would indicate filter loading.

The mechanical dehumidification subsystem has sensors that monitor temperature and humidity following each of the coils. The first evaporation coil has a temperature sensor, 0615, and a humidity sensor, 0616. The super-heat coil has a temperature sensor, 0617, and a humidity sensor, 0618. The second evaporator coil has a temperature sensor, 0619, and a humidity sensor, 0620. The first compressor has a high side pressure sensor, 0621, and a low side pressure sensor, 0622. The second compressor has a high side pressure sensor, 0623, and a low side pressure sensor, 0624. These sensors collectively provide information for adjusting the operation of the two closed loop refrigerant systems by cycling on and off compressors one and two using commands from the controller at, 0625, and 0626, respectfully. In addition, the differential air pressure across the coils is monitored using a differential pressure sensor, number 0627, to indicate any potential flow path blockage in the coils.

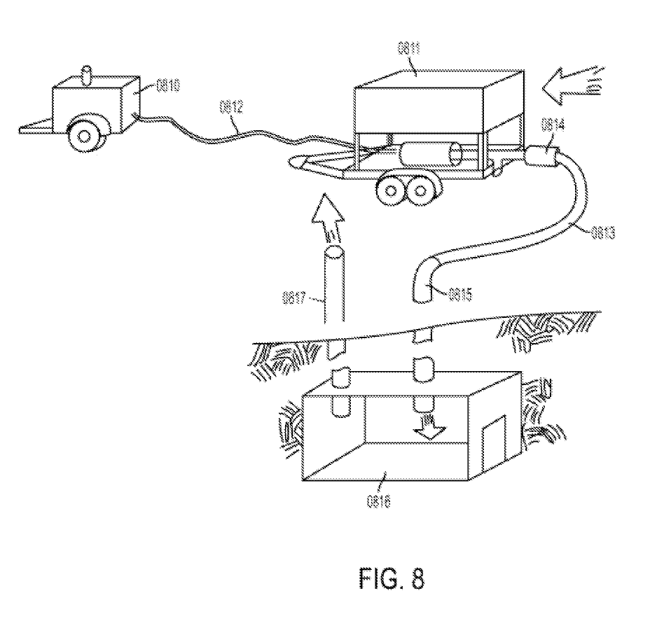

The twin lobe positive displacement blower subsystem is monitored through supply air volume sensor, 0628, supply air velocity sensor, 0629, and supply air temperature sensor, 0630, located in an air monitoring station adjacent to the discharge, as illustrated in FIG. 8, number 0814.

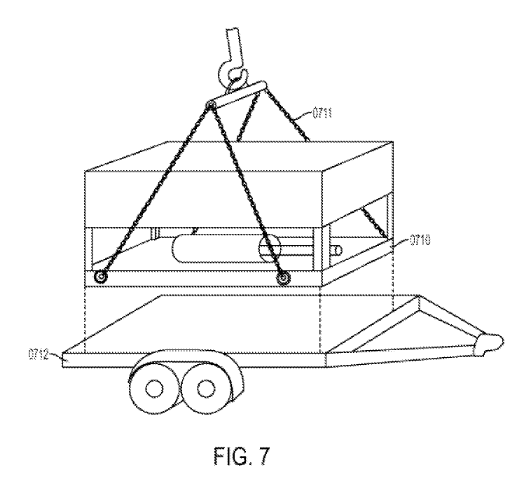

FIG. 7 illustrates the flexibility of the skid mounted environmental conditioning unit, number 0710. The unit can be hoisted using attached lifting points, lifting bail, lifting eye, or other permanently mounted fittings for lifting and appropriate harness as in number 0711. Additionally, the environmental conditioning unit can be mounted on a trailer or truck bed as in number 0712, FIG. 7; see also FIG. 3B.

FIG. 8 depicts a confined space. In this embodiment of the system a portable power source, number 0810, provides the necessary electrical power to the environmental conditioning unit, number 0811, through a power cable, number 0812. The outlet pipe from the environmental conditioning unit is connected to one of a number of optional types of flexible pipes, number 0813, via an air monitoring station, number 0814. The flexible pipe is connected to the top of a cased bore hole, number 0815, with one of several types of quick connect fittings. The air is discharged into the confined space, number 0816, at a rate that allows for multiple complete air exchanges per hour, providing adequate volume and quickly flushing any hazardous gases, that might be initially contained in the confined space. In this particular embodiment, the air is returned through a return air borehole, number 0817.

Another embodiment of the invention does not have a return air borehole. The supplied air exhausts out of the confined space into the atmosphere surrounding the confined space.

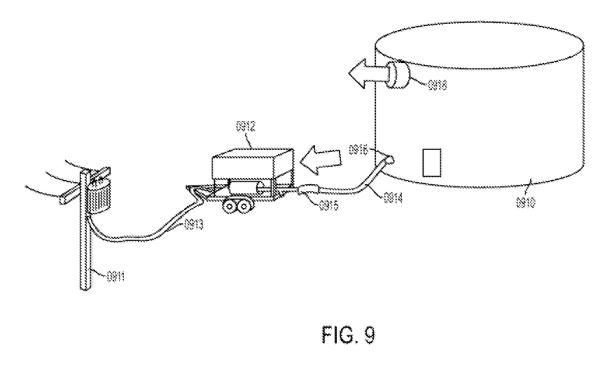

An additional embodiment of the invention is illustrated in FIG. 9 where the confined space is a storage tank, number 0910. In this embodiment of the system, power is provided from an existing power pole, number 0911. It provides the necessary electrical power to the environmental conditioning unit, number 0912, through a power cable, number 0913. The outlet pipe from the environmental conditioning unit is connected to one of a number of optional types of flexible pipes, number 0914, via an air monitoring station, number 0915, where air temperature is measured by a temperature sensor, humidity is measured by a humidity sensor, and the differential pressure between inside the flexible pipe and outside the flexible pipe, at the exit of the environmental conditioning unit, is measured by a differential pressure sensor. The flexible pipe is connected to the fitting provided on the storage tank, number 0916, with one of several types of quick connect fittings.

The air is supplied to the confined space at a rate that allows for multiple complete air exchanges per hour, providing adequate volume and quickly flushing any hazardous gases through a return air hole, number 0917.

1. A method, apparatus, or system for providing controlled atmosphere in confined spaces comprising:
an environmental conditioning unit capable of dehumidifying the air passing through it, and,
in fluid communication with said environmental conditioning unit, a blower, compressor, or other device configured to cause air to move through the environmental conditioning unit,
wherein the environmental conditioning unit and blower, compressor, or other device is in fluid communication with a flexible hose, tube, pipe, duct, or other conduit that can be connected to a confined space, and
wherein the environmental conditioning unit, blower, compressor, or other device, and flexible hose, tube, pipe, duct, or other conduit make up an integrated and portable Safe Air System (SAS) configured to be mounted on a trailer for towing over roads and rough terrain, airlifted via helicopter (for instances when the SAS would be needed in a remote location quickly), and placed on a truck, ship, or stationary wing aircraft.

2. The method, apparatus, or system of claim 1 wherein the environmental conditioning unit is configured to heat the air passing through it.

3. The method, apparatus, or system of claim 1 wherein the blower, compressor, or other device is a blower.

4. The method, apparatus, or system of claim 1 wherein the flexible hose, tube, pipe, duct, or other conduit is a flexible pipe.
